(19) United States
(12) Patent Application Publication
(10) Pub. No.: US 2007/0175939 A1
(43) Pub. Date: Aug. 2, 2007

(54) Character harness with storage pouches

(75) Inventors: Katherine Gold, Denver, CO (US); Lynn Rosen, Parker, CO (US)

Correspondence Address: REILLY INTELLECTUAL PROPERTY LAW FIRM, 1554 EMERSON STREET, DENVER, CO, 80218, US

(73) Assignee: Gold Bug, Inc.

(21) Appl. No.: 11/726,826

(22) Filed: Mar. 23, 2007

Related U.S. Application Data
(63) Continuation-in-part of application No. 11/090,808, filed on Mar. 25, 2005.

(51) Int. Cl. A45F 4/02; A45C 15/00; A62B 35/00; B60R 22/00

(52) U.S. Cl. 224/576; 224/153; 119/770

(57) ABSTRACT

A child's harness including at least one storage pouch and in the form of a novelty character, the limbs of the character attached to shoulder straps and a waist strap of the harness. The harness is secured with waist and shoulder strap closure members and includes a character tail.

### CROSS-REFERENCE TO RELATED APPLICATIONS

The present application is a continuation-in-part of patent application Ser. No. 11/090,808, filed Mar. 25, 2005 for CHARACTER HARNESS WITH STORAGE POUCH, by Katherine Gold and Lynn Rosen and assigned to the assignee of this invention and incorporated by reference herein.

### FIELD

The present apparatus relates to a child's harness; and more particularly to a novel and improved character harness that is also a backpack wherein the body portion of the harness is in the form of a novelty character of animal or human form to define a storage pouch, the shoulder and waist straps of the harness representing the limbs or extremities of the character, and a tether attached to the harness in the form of a character tail.

### BACKGROUND

Prior art patents include a number of child harness systems wherein the child harness is adjustable in the rear of a waist member and the shoulder straps extend solely from the same waist member making the harness uncomfortable to the wearer. Further, many children object to wearing a harness. Prior to the present device, there has been no satisfactory harness, which is comfortable and capable of restraining a child who is walking and at the same time providing a novelty carrier or backpack, which encourages use by the child.

### SUMMARY

The present harness is adjustable from the front, allowing for easy adjustment, and includes a carrier backpack in the shape of a novelty character with a storage pouch, so as to encourage a child to wear the harness.

In one aspect, a child harness is provided, which includes a fabric shell defining a body portion of a character having a pouch, a head at the upper end of the body portion, and pairs of upper and lower limb members extending from the body portion, the upper limb members forming shoulder strap members to be worn over the shoulders of a wearer, the lower limb members forming waist strap members to encircle the waist of a wearer, and the upper and lower members being secured in such a way as to form a restraint member. An auxiliary restraint member may extend across the front of the body between the shoulder straps. The shoulder straps and waist straps are adjustable and the harness includes a detachable tether in the form of a character tail.

In a further aspect, the fabric shell defines the body of a character of animal or human form also having a head at the upper end of the body portion and pairs of limbs or upper and lower extremity members extending from the body portion. The upper limb members include shoulder strap members adapted to extend over the shoulders of a wearer, the shoulder strap members forming extensions of the upper limb members and the lower limb members include waist strap members adapted to encircle the waist of a wearer. The shoulder strap members and the waist strap members are adapted to be secured together in such a way as to form a restraint member. The shoulder straps and waist straps are adjustable and the harness includes a detachable tether in the form of a character tail.

There has been outlined, rather broadly, the more important features in order that the detailed description thereof that follows may be better understood, and in order that the present contribution to the art may be better appreciated. There are, of course, additional features that will be described hereinafter and which will form the subject matter of the claims appended hereto. In this respect, before explaining at least one embodiment in detail, it is to be understood that the embodiments are not limited to the details of construction and to the arrangements of the components set forth in the following description and is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes recited. It is important, therefore, that the claims be regarded as including such equivalent constructions.

### BRIEF DESCRIPTION OF THE DRAWINGS

FIG. 1 is a perspective view of an embodiment of the harness/backpack in the shape of an animal on the shoulders of a wearer;

FIG. 2 is a rear elevational view of the embodiment of FIG. 1;

FIG. 3 is a front elevational view of the embodiment of FIG. 1;

FIG. 4 is a top plan view of the embodiment of FIG.

FIG. 5 is a bottom plan view of the embodiment of FIG. 1;

FIG. 6 is a side view of the embodiment of FIG. 1;

FIG. 7 is an opposite side view of the view shown in FIG. 6;

FIG. 8 is a cross-sectional view taken about lines 8-8 of FIG. 7 of the harness;

FIG. 9 is a perspective view of another embodiment of the harness/backpack in the shape of an animal on the shoulders of a wearer;

FIG. 10 is a front elevational view of the harness shown in FIG. 9 with the harness in a fastened state;

FIG. 11 is a side view of the harness of FIG. 9; and

FIG. 12 is a rear elevation view of the harness of FIG. 9.

### DETAILED DESCRIPTION

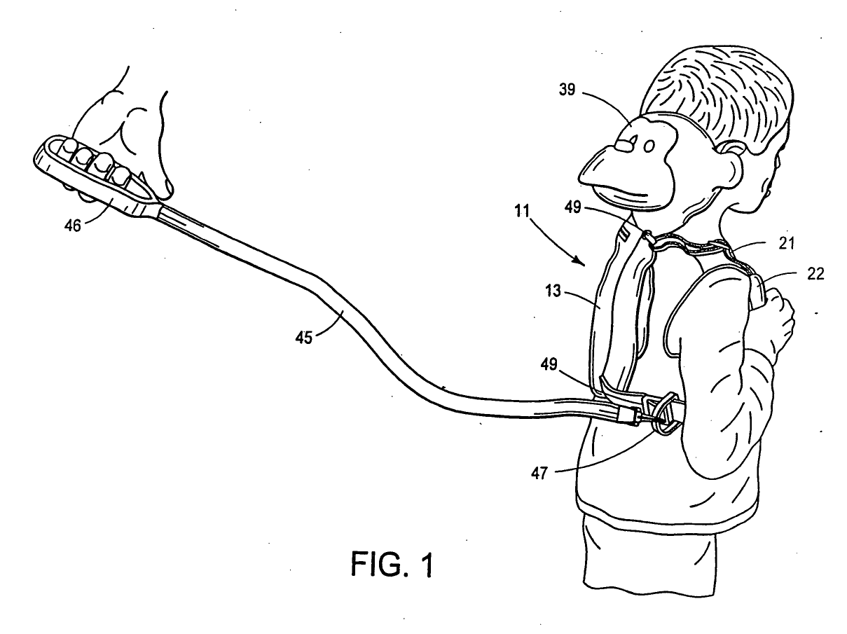

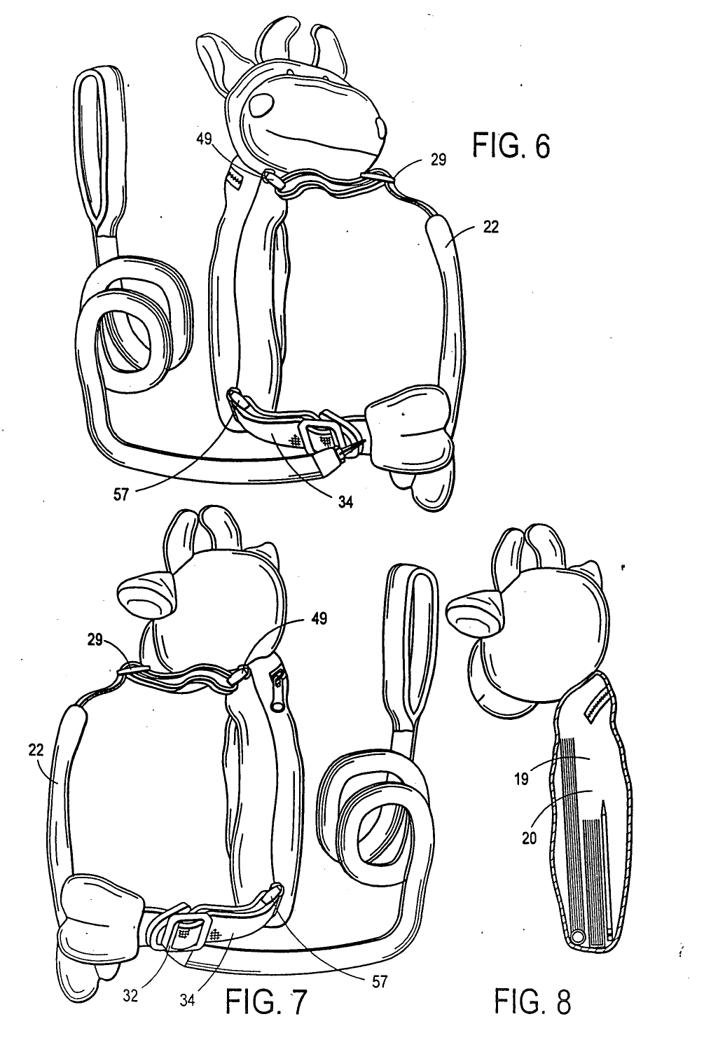

As shown in FIGS. 1 through 8 and more particularly in FIGS. 1-3, there is demonstrated a character harness 11 in the form of a novelty character in use on a wearer, specifically a child. The device 11 includes a body portion or torso 13, having an outer fabric shell 14 stuffed with cushioning material or padding so as to be of generally ovate or egg-shaped configuration and having a back panel 15, a front panel 17 and a storage compartment which is in the form of a pouch 19 as shown in FIG. 8. The body portion 13 may be in the form of a character, animal or human torso, and head member 39 also is padded and attached to an upper portion 18 of the body 13 and may be in the form of a human or animal head. Shoulder strap members 21 are designed to be worn over the shoulder of a wearer, typically a child and are attached to the body or torso portion 13. A waist strap member 23 also extends from the body portion 13 and the combination of the shoulder strap members 21, the waist strap member 23 and the body portion 13 form a harness/backpack with the shoulder strap members 21 and the waist strap member 23 forming limbs or extremities of the character.

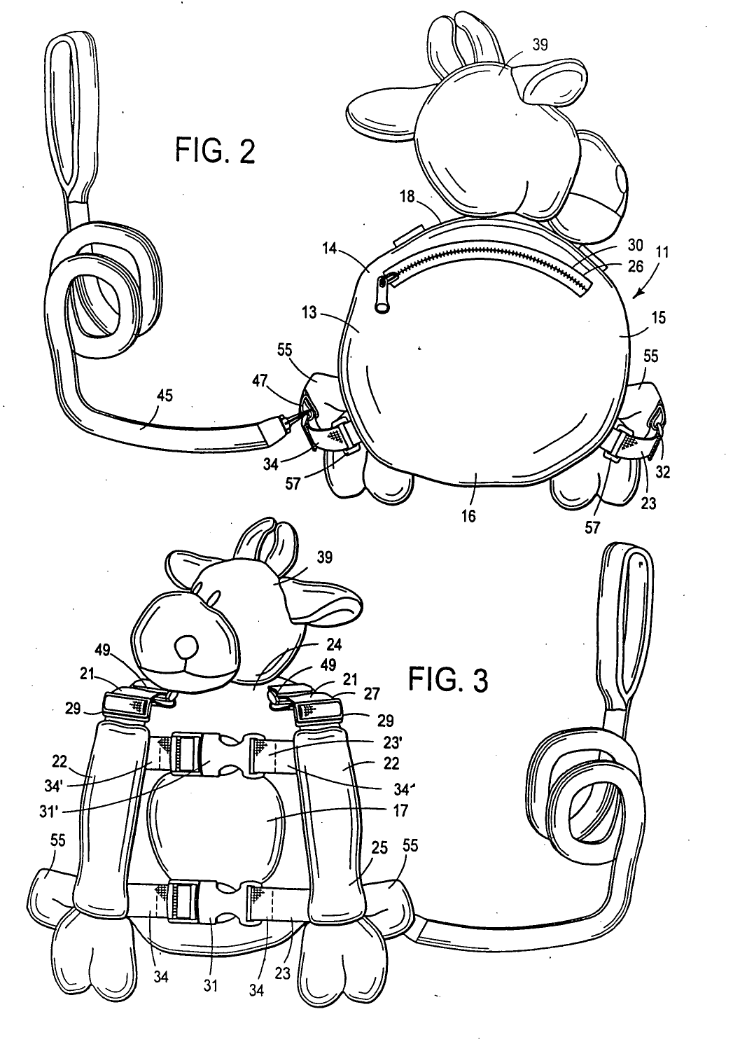

The outer shell 14 of the body portion 13 is composed of a soft fabric, either cotton or polyester, and has a rounded shape. The back panel 15 and the front panel 17 are sewn together and there is a pouch or storage member 19 in an upper portion 18 of the back panel 15. The pouch 19 has an interior portion 20, which is capable of holding small articles, such as, small toys or other miscellaneous items as shown in FIG. 8. An opening 26 in the pouch 19 may be closed with a zipper 30 or any other type of closure device, such as a Velcro® closure. Attached to the body portion 13 along an upper portion 24 of the front panel are the shoulder strap members 21. The shoulder strap members 21 are preferably nylon straps connected to the upper portion 24 of the front panel 17 with plastic loop retainers 49 shown in FIGS. 1, 3, 6 and 7. Upper ends 27 of the shoulder strap members 21 each contain an adjustment device 29 which is formed of plastic or any other rigid material and allows for lengthening or shortening of the shoulder straps 21. Depending upon the size of the wearer, the harness may be easily adjusted to snugly fit around the shoulders and torso of the wearer. Cushioning members 22 are secured around the shoulder strap members 21 below the adjustment devices 29. The cushioning members 22 are formed of a soft material, such as, cotton or polyester and contain a moderate amount of fill or stuffing so that they are slightly padded. The cushioning members 22 form a padded area along the chest area of the wearer providing for a comfortable fit. Terminal or lower ends 25 of the shoulder strap members 21 are secured to the waist strap member 23 which includes two nylon side straps 34 attached with plastic loop retainers 57 to opposite sides of and extending forwardly from the lower body 16. See FIGS. 2 and 5. The lower ends or hands 25 of the shoulder strap members 21 are attached to each waist strap member 34 adjacent to a waist closure member 31 which will be discussed in more detail. The straps 34 extend from a lower portion 16 of the body portion 13 and are designed to partially encircle the waist of a user. This is shown in FIGS. 2, 5, 6 and 7. Each strap 34 has an adjustment device 32, which allows for shortening or lengthening of each waist strap member 34. The dual waist strap members 34 are attached together at terminal ends with the waist closure member 31, preferably a quick release latch. The waist strap members 34 have a cushioned portion 55, which is located between the waist adjustment member 32 and the closure member 31. As described previously, the cushioning portion 55 is made of a soft supple material, which is lightly padded. The cushioned portion prevents undue rubbing of the waist straps along the waist area of a wearer. An upper strap member 23′ extends between the shoulder strap members 21 and partially encircles or spans the midsection of the body 13 in the same manner as the waist strap 23 and like parts are correspondingly enumerated. The upper strap member 23′ includes two nylon straps 34′ which are attached together at terminal ends with a closure member 31′. The upper and lower waist closures 31 and 31′ are aligned so that the device 11 is securely fastened around the torso and chest of a user forming a restraining unit. The upper strap member 23′ prevents a child from slipping out of the harness or removing the shoulder straps 21. The location of the body portion 13 and the connection between the shoulder strap members 21 and the body portion 13, as well as the extension of the waist straps 34 from the lower portion 16 of the body portion 13 provides for a harness 11 which is easy to adjust and is less likely to become tangled. Further, the shoulder straps 21 in combination with the upper and lower straps 23 and 23′ provide for a comfortable harness.

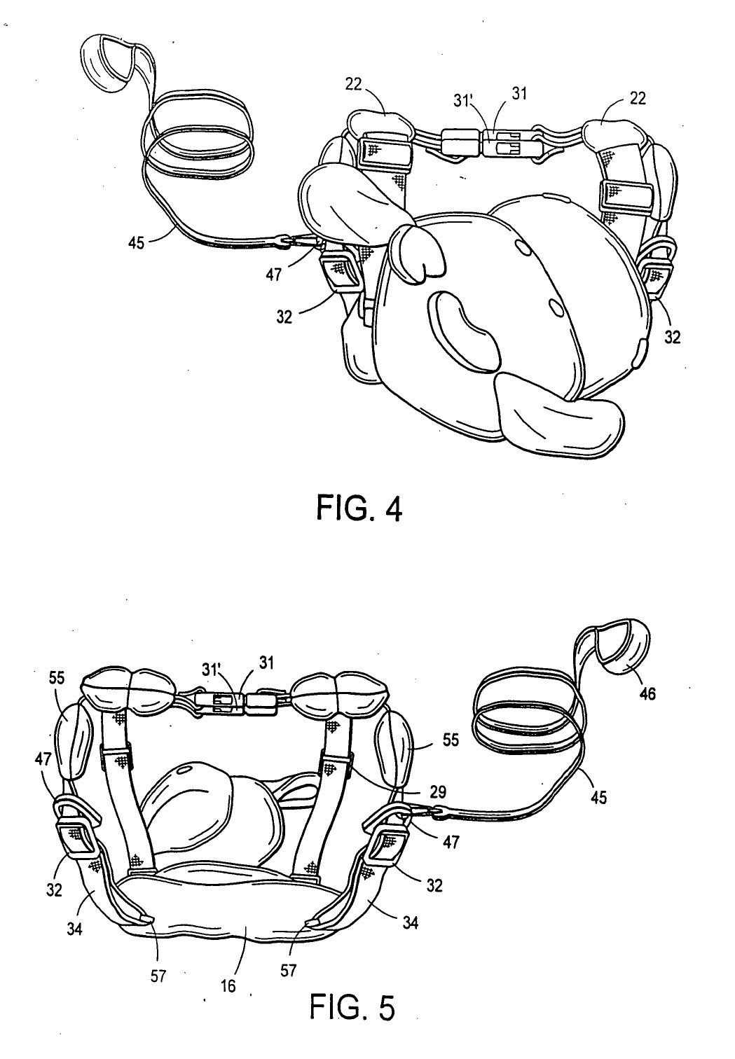

The waist strap 23 also includes at least two tether members 47, as shown in FIGS. 4 and 5, which are formed of plastic and are in the form of a link or loop. A tether 45 may be attached to the tether loop 47 with a tether hook 49. The tether 45 is preferably in the form of a long strip of material with a handle portion 46. An opposite end 48 of the tether 45 contains the tether hook 49.

It is also possible that the tether loop 47 is provided on the lower portion 16 of the body portion 13.

The tether 45 should be of sufficient length to allow a child or wearer who is linked to the tether by the device 11 enough length to freely move around but short enough to allow a parent grasping the tether handle 46 to prevent tangling and loss of control of the child.

Attached to the upper portion 18 of the body portion 13 is the head member 39 which is preferably in the form of a character, such as, an animal as shown in the drawings. The body portion 13 is in the shape of a character body or torso and the shoulder strap members 21 are preferably in the form of character arms as shown in FIG. 4 and the waist strap members 34 which are in the form of character legs or extremities. The tether 45 is preferably in the form of a character tail. The device 11 when placed around the torso of a child or wearer, and securely fastened as described is in the form of a character receiving what is known as a “piggy back” ride from the child. The character will have its arms and legs wrapped around the shoulders and waist of the child. The pouch 19 enables a child or adult to place items within the pouch 19 and securely close the pouch 19 with the zipper 30.

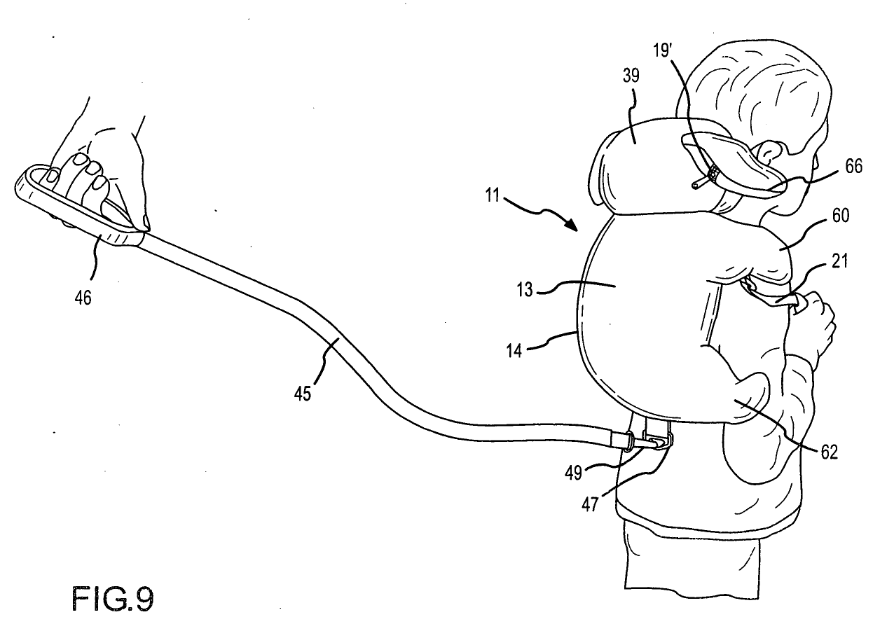

The location of the tether loop 47 allows a child or wearer to freely move around, especially in front of an adult, without pulling the child around to face the adult or the party controlling the handle portion 46, which is the case with tethers attached to a front of a harness. In certain desired situations, the loop 47 may be attached to any strap members, including the shoulder straps 21 and the upper and lower straps 23′ and 23. Preferably, the tether loop 47 is attached to the waist strap 34, which prevents the wearer from losing his or her balance if the adult gives a gentle tug on the tether 45. It is also contemplated, however, that the tether is secured to the lower portion 16 of the body portion 13, as shown in the embodiment of FIGS. 9-12. A tether attached to the waist of a child is less likely to cause the child to lose their balance due to the child's center of gravity being located along the torso area.

In use, the harness 11 is placed with the front panel 17 along the back of a child. The shoulder straps 21 are placed over the shoulders of a child and the waist strap 23 is placed around the waist of a child. The lower strap members 34 are secured with the closure member 31 and the upper strap members 34′ also secured with the closure member 31′. The shoulder strap members 21 may be adjusted with the adjustment device 29 and the waist strap 23 may also be adjusted with the adjustment device 32. The tether 45 may then be attached to the harness 11 with the tether loop 47 and the tether hook 49. An adult may then grasp the tether handle 46 to retain control of the child. The child may place toys or other items in the pouch 19 and close it with the zipper 30 to prevent the items from falling out. In this way, a parent may control the movements of the child without fear of losing the child in a crowded environment. It is also helpful when the adult has numerous children to supervise and allows the adult to keep the children safe and under control with one hand while leaving the adult's other hand free. If desired, the tether 45 may be completely removed so the child may simply wear the device 11 without the tether 45.

A further aspect of the harness is shown in FIGS. 9-12. With reference to this embodiment and FIGS. 9-12, the same reference numerals have been used to designate the same or similar elements as those shown in FIGS. 1-8.

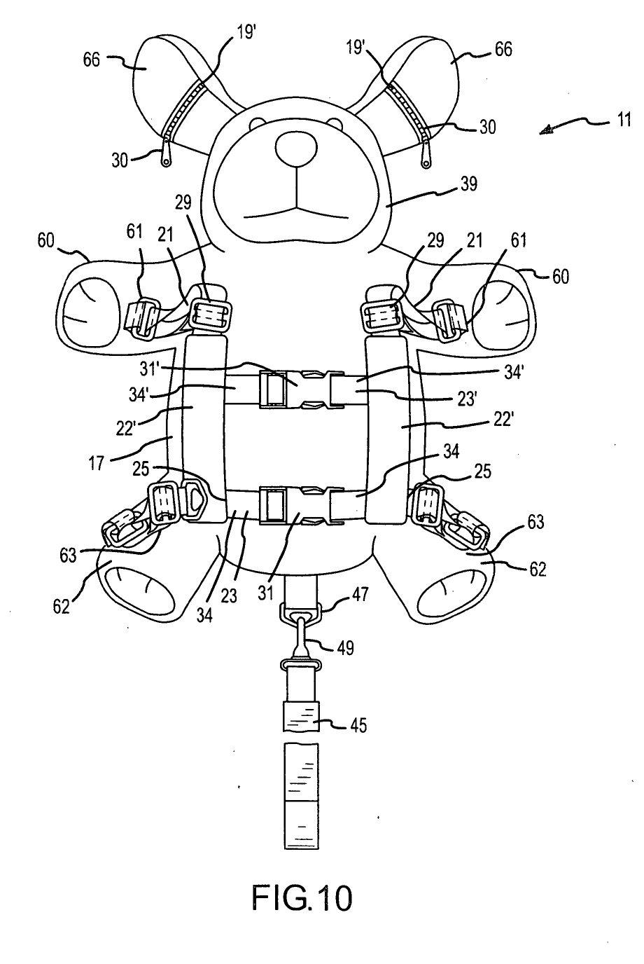

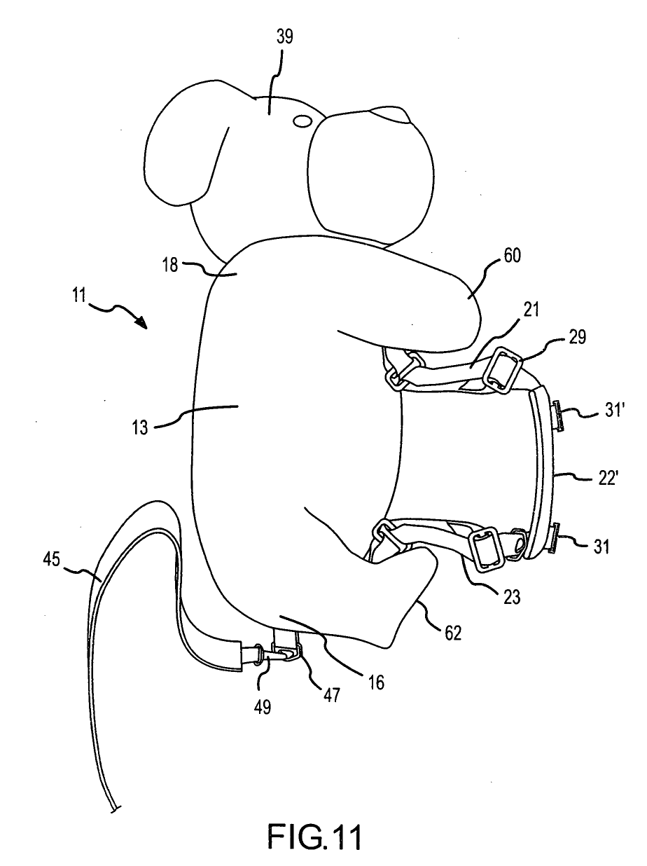

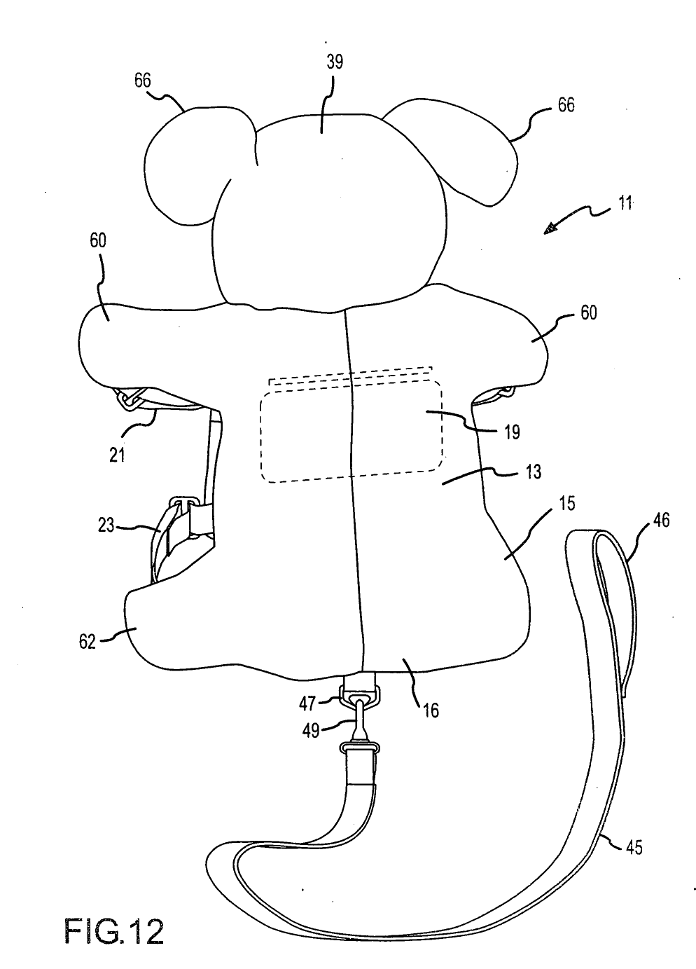

The aspect shown in FIGS. 9-12 is similar to that of FIGS. 1-8 but has several modifications. FIG. 9 shows the character harness 11 in the form of a novelty character in use on a wearer, specifically a child. As with the previously described embodiment, the device 11 includes a body portion or torso 13 having an outer fabric shell 14 stuffed with cushioning material or padding so as to be of generally ovate or egg-shaped configuration and having a back panel 15 and a front panel 17. A head member 39 is also padded and attached to an upper portion 18 of the body 13 and may be in the form of a human or animal head. As shown in FIGS. 10 and 11, storage members in the form of pouches 19′ are provided in the ears of the character head member 39, which can be closed by a zipper 30 or other suitable closure means, such as Velcro®. However, as with the previously described embodiment, the storage pouch or compartment also can be provided in the back panel 15 as shown in FIG. 12. The storage pouch 19 may be large enough to hold larger items as shown in FIG. 8 or may also be smaller in size as shown in FIG. 12. Variations in size are shown by way of example only and not limitation as the size of the storage pouch 19 may vary.

In the aspect of FIGS. 9-12, the character, which resembles a stuffed toy animal, includes stuffed or filled upper limb members 60 and lower limb members 62, which are adapted to extend over the shoulders and around the waist, respectively, of the wearer. The shoulder strap members 21 are secured to midportions 61 of the respective upper limbs 60 of the character, and are adapted to extend over the shoulder of a wearer, typically a child. A waist strap member 23 is secured to a midportion 63 of each lower limb 62. The location of the attachment of the waist strap member 23 to the midportion 63 of each lower limb 62, allows for the padded limb members 62 to partially encircle the waist of a wearer, allowing for a more comfortable, partially padded fit around the waist of a wearer. The combination of the shoulder strap members 21, the waist strap members 23 and the body portion 13 form a harness/backpack.

As with the previously described aspect, the outer shell 14 of the body portion 13 is composed of a soft fabric, either cotton or polyester, and can be a plush fabric that resembles the fabric of a stuffed toy animal, and has a rounded shape. The character can be provided with more filling or stuffing than in the previously described embodiment so that the harness resembles a stuffed toy animal. The back panel 15 and the front panel 17 are sewn together. A pouch or storage member 19 can be positioned in a central to upper portion 18 of the back panel 15, or as described above, the storage members 19′ can be provided in the ears 66 of the character, depending on the size of the ears 66, as shown in FIGS. 9 and 10. The storage members 19′ each have an interior portion, which is capable of holding small articles. An opening 26 in the pouch 19 may be closed with a zipper 30, as shown in FIGS. 9 and 10, or any other suitable type of closure device, such as Velcro®.

Attached to the upper limb members 60 are the shoulder strap members 21. The shoulder strap members 21 may be secured or attached along any portion of the upper limb members but by way of example only, are shown attached along the mid-portion 61 of the upper limb members 60. The shoulder strap members 21 are preferably nylon straps sewn to the midsection 61 of each of the upper limb members 60 as shown in FIGS. 10 and 11. The shoulder strap members 21 each contain an adjustment device 29 which is formed of plastic or any other rigid material and allows for lengthening or shortening of the shoulder straps 21. Depending upon the size of the wearer, the harness may be easily adjusted to snugly fit around the shoulders and torso of the wearer.

Cushioning members 22′ are secured around the shoulder strap members 21 below the adjustment devices 29. The cushioning members 22′ are formed of the plush or soft material, such as, cotton or polyester and contain a moderate amount of fill or stuffing so that they are slightly padded. The cushioning members 22′ form padded surface portions along the chest area of the wearer providing for a comfortable fit as well as providing a soft surface for a wearer to grasp or rub.

In this embodiment, terminal or lower ends 25 of the cushioning members 22′ are secured to the waist strap member 23, which includes two nylon side straps 34, each of which is sewn at a terminal end to a respective lower limb member 62. The nylon side straps 34 may be attached along any point on the lower limb member 62 but is shown attached along the mid-portion 63. See FIGS. 11 and 12. The lower ends 25 of the cushioning members 22′ are attached to each of the two nylon side straps 34 adjacent to a waist closure member 31, as described above. The straps 34 are designed to partially encircle the waist of a user. This is shown in FIGS. 10-12.

As with the previously described embodiment, each strap 34 has an adjustment device 32, which allows for shortening or lengthening of each waist strap member 34. The dual waist strap members 34 are attached together at terminal ends with the waist closure member 31, preferably a quick release latch. An upper strap member 23′ extends across the chest in the same manner as the waist strap 23 and like parts are correspondingly enumerated. The upper strap member 23′ includes two straps 34′ which are attached together at terminal ends with a closure member 31′. The upper and lower waist closures 31 and 31′ are aligned so that the device 11 is securely fastened around the torso and chest of a user forming a restraining unit. The upper strap member 23′ forms an auxiliary restraint by preventing a child from slipping out of the harness, such as by removing the shoulder straps 21.

A tether member 47 is secured to the lower portion 16 of the body portion 13, as shown in FIGS. 9-12. The tether member 47 is formed of plastic and is in the form of a link or loop. A tether 45 may be attached to a tether loop 47′ with a tether hook 49. The tether 45 is preferably in the form of a long strip of material, preferably the same plush fabric that forms the harness so that the tether resembles the tail of the animal. The tether includes a handle portion 46. An opposite end 48 of the tether 45 contains the tether hook 49. The tether 45 should be of sufficient length to allow a child or wearer who is linked to the tether by the device 11 enough length to freely move around but short enough to allow a parent grasping the tether handle 46 to prevent tangling and loss of control of the child. The tether hook 49 may also be connected to the waist strap member 34, the shoulder strap member 21 or the tether loop 47.

It is therefore to be understood that while different embodiments are herein set forth and described, the above and other modifications may be made in the composition of materials as well as construction and arrangement of parts without departing from the spirit and scope of the device as defined by the appended claims and reasonable equivalents thereof.

We claim:

1. A child's harness comprising:
a fabric shell defining a body portion of a character of animal or human form, a head at one end of said body portion, and pairs of upper and lower limb members extending from said body portion;
said upper limb members including shoulder strap members adapted to extend over the shoulders of a wearer;
said lower limb members including waist strap members adapted to encircle the waist of a wearer; and
wherein said shoulder strap members and said waist strap members are adapted to be secured together to form a restraint member.

2. A child's harness according to claim 1, further comprising a tether linked to a lower portion of said body portion of the character.

3. A child's harness according to claim 1, comprising a tether linked to said restraint member.

4. A child's harness according to claim 1, wherein said character is an animal and said detachable tether is in the form of a character tail.

5. A child's harness according to claim 1, further comprising a storage pouch positioned in said body portion.

6. A child's harness according to claim 1, wherein said head includes ears, and wherein at least one storage pouch is provided in the ears.

7. A child's harness according to claim 1, wherein said shoulder strap members and said waist strap members include an auxiliary restraint.

8. A child's harness according to claim 1, wherein said shoulder strap members are secured along a mid-portion of said upper limb members.

9. A child's harness according to claim 1 wherein said waist strap members are secured along a mid-portion of said lower limb members.

10. A child's harness according to claim 1, further comprising cushioning members, wherein said shoulder strap members and said waist strap members are secured to said cushioning members.

11. A child's harness according to claim 5, wherein said storage pouch has a closure means, wherein said closure means is a zipper or Velcro®.

12. A child's harness according to claim 5, wherein said at least one storage pouch has a closure means, wherein said closure means is a zipper or Velcro®.

13. A child's harness according to claim 1, wherein a front panel of said body portion is coextensive with a dorsal area of a wearer.

14. A child's harness comprising:
a fabric shell having a front and back panel, said back panel including an opening into the interior of said shell;
said fabric shell at least partially filled with cushioning material and being of generally ovate configuration;
appendages extending from said body member, upper appendages adapted to extend over the shoulders of a wearer and lower appendages adapted to extend around the waist of a wearer;
free ends of said shoulder strap members releasably secured to each end of waist strap members;
each of said waist strap member ends terminating in a closure member;
an auxiliary restraint member between said shoulder strap members; and
a detachable tether linked to a lower portion of said back panel.

15. A child's harness according to claim 14, wherein said opening includes a zippered pouch.

16. A child's harness according to claim 14, wherein said shell defines a central body member in the form of a character having a head and at least four limbs forming said upper and lower appendages.

17. A child's harness according to claim 16, wherein said limbs are adapted to partially encircle a torso of a wearer.

18. A child's harness according to claim 14, wherein said auxiliary restraint member comprises at least one securing member.

19. A child's harness and backpack for restricting the movement of a child, comprising in combination:
(a) a padded body member having a front and back panel, wherein said body member is defined by a character having a head and padded upper and lower limb members;
(b) a pair of shoulder strap members having two ends, one of said ends connected to an upper limb of the body member and a second of said ends connected to an auxiliary member;
(c) a tether having a looped handle at one end and a connection member at a second end for affixing said second end of said tether to said body member;
(d) a waist strap member secured at opposite ends to a lower limb member and at a midportion, to said cushioning member;
(e) said shoulder strap members having releasable securing members, said shoulder strap securing member spaced above said waist strap securing member.
